(19) United States
(12) Patent Application Publication
(10) Pub. No.: US 2009/0146882 A1
(43) Pub. Date: Jun. 11, 2009

(54) METHOD AND SYSTEM OF GENERIC POSITION SIGNALLING FOR CELLULAR NETWORKS

(75) Inventors: Ismo Halivaara, Tampere (FI); Jari Syrjarinne, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/329,487

(22) Filed: Dec. 5, 2008

Related U.S. Application Data
(60) Provisional application No. 61/012,391, filed on Dec. 7, 2007.

(51) Int. Cl. G01S 3/02

(52) U.S. Cl. 342/451; 342/450

(57) ABSTRACT

Systems and methods provide location support for assisted navigation systems, for example, with respect to assistance data specifications and protocols in systems without impacting a cellular system-specific control plane protocol. Location support for cellular systems can be introduced into only the user plane of a particular cellular system by including/introducing certain relevant information to existing parameters within the user plane. Additionally, support for new cellular systems is introduced into the user plane protocol by defining its “identification” to the protocol.

### FIELD OF THE INVENTION

The present invention related generally to the filed of assisted navigation systems. More particularly, the present invention relates to assistance data specifications and protocols for navigation systems in cellular networks without impacting cellular system-specific control plane protocols.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Location services based on the location of mobile devices are becoming increasingly widespread. Assistance data for assisted navigation systems, such as global navigation satellite systems (GNSS), have been specified and standardized for cellular systems, e.g., assisted global positioning system (AGPS) and global assisted navigation satellite system (GANSS). A GNSS can comprise a network of satellites that broadcasts navigation signals including time and distance data. GNSS receivers pick up these broadcasted navigation signals and calculate a precise global location based thereon. Examples of GNSS include, but are not limited to, global positioning systems (GPS) and GALILEO.

The delivery of such assistance data can be built on top of cellular system-specific control plane protocols including, e.g., the radio research location services protocol (RRLP) for GSM networks, the radio resource control (RRC) layer of layer 3 in wideband code division multiple access (WCDMA) networks, and IS-801 for CDMA networks.

Common features exist in a majority, if not all of the protocols including, but not limited to those described above for delivering assistance data. However, when differences arise, a terminal's software must either have an adaptation layer for the relevant protocols or is limited to supporting only some, but not all of the protocols. Additionally, whenever a new cellular system (e.g., networks using worldwide interoperability for microwave access (WiMAX) technology or a standard such as the long term evolution (LTE) standard, a successor to GSM), is brought into use, a terminal must adapt to the specifics of that system/network as well.

In response to the above, the Open Mobile Alliance (OMA) has defined a user plane protocol referred to as secure user plane location (SUPL) 1.0.

SUPL employs user plane data bearers for transferring location assistance information such as GPS assistance data, as described above, for carrying positioning technology-related protocols between terminal, e.g., a mobile communication device and its operating network. SUPL is intended to be an alternative and, at the same time, a complement to the existing standards based on signaling in the mobile network control plane. SUPL assumes that a mobile or other network can establish a data bearer connection between a terminal and some type of location server.

It should be noted that SUPL utilizes existing standards whenever it is possible, and it is envisioned that SUPL is to be extensible thus enabling the use of additional positioning technologies so that these different positioning technologies and/or systems utilize the same mechanism for transferring location assistance information.

Utilizing SUPL involves the wrapping of control plane protocol messages in order to move the signalling functionality of location assistance information from the control plane to the user plane, although SUPL is reliant upon the underlying system-specific control plane protocols.

### SUMMARY OF THE INVENTION

Various embodiments provide location support, e.g., support for satellite-based positioning, for assisted navigation systems, for example, with respect to assistance data specifications and protocols in systems without impacting a cellular system-specific control plane protocol. Location support for cellular systems can be introduced into only the user plane of a particular cellular system by including/introducing certain relevant information to existing parameters within the user plane. Therefore, the control plane specifications of a particular cellular system are not affected or altered. Additionally, no cellular system-specific location protocol needs to be introduced into the particular cellular system, where support for new cellular systems is introduced into the user plane protocol by defining its “identification” to the protocol. That is, the relevant information introduced into the user plane is defined.

Various embodiments enable fast and easy positioning support with regard to new cellular systems while, e.g., saving time and reducing the cost associated with implementing such embodiments because only minimal changes are needed, as described above. Moreover, various embodiments can improve the reliability of cellular systems/networks where they are implemented because already-tested implementations can be used as they are by only introducing new values for certain parameters. Additionally, backward compatibility issues can be avoided as well.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a flow chart illustrating operations performed in accordance with various embodiments;

FIG. 2 is an overview diagram of a system within which the present invention may be implemented;

FIG. 3 is a perspective view of a mobile telephone that can be used in the implementation of the present invention; and

FIG. 4 is a schematic representation of the telephone circuitry of the mobile telephone of FIG. 3.

### DETAILED DESCRIPTION OF THE PREFERRED EMBODIMENTS

Various embodiments provide location support, e.g., support for satellite-based positioning, for assisted navigation systems, for example, with respect to assistance data specifications and protocols in systems such as those utilizing, for example, the 3^{rd} Generation Partnership Project (3GPP) LTE standard, WiMAX technology, and the OMA SUPL protocol without impacting a cellular system-specific control plane protocol. A control plane can be considered to be a functional plane containing the signaling structure for user bearer management. Generally, the control plane can designate the circuit switched and packet switched wireless signaling networks which enable, e.g., voice, data, and supplementary service operations. A user plane on the other hand, may designate a functional plane, where information therein is a part of the wireless user data and is transported over user bearers, such as the wireless packet data network of a cellular system or short message service (SMS).

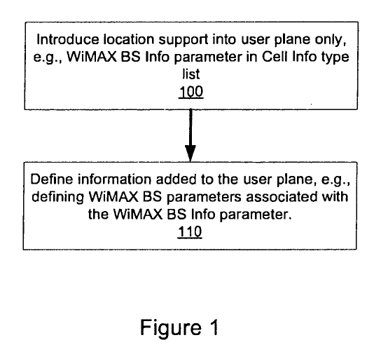

As illustrated in the flow chart of FIG. 1, and in accordance with various embodiments, location support for cellular systems can be introduced into only the user plane of a particular cellular system at 100 by including/introducing certain relevant information to existing parameters within the user plane. Therefore, the control plane specifications of a particular cellular system, e.g., LTE or WiMAX, are not affected or altered. Additionally, no cellular system-specific location protocol needs to be introduced into the particular cellular system. At 110, support for new cellular systems is introduced into the user plane protocol by defining its “identification” to the protocol. That is, the relevant information introduced into the user plane is defined.

It should be noted that a basic level of positioning support is achieved without any cellular system-specific modifications. Moreover, if an enhanced positioning performance level of operation requires cellular system-related information, such as the relationship between, e.g., cellular and satellite time, such information can be provided with a general structure that enables easy addition of new systems.

For example, in a cellular system that utilizes the OMA SUPL protocol, support for, e.g., WiMAX, can be introduced by adding base station (BS) information to one or more existing parameters in the user plane. Table 1 below indicates that in this scenario, the BS information is added to the “Cell Info” parameter type list. Therefore, the message level is not affected.

TABLE 1

| Parameter | Presence | Value/Description |
|---|---|---|
| Location ID | — | Describes a globally unique |
| | | cell or wireless local area |
| | | network (WLAN) access point |
| | | (AP) identification of the most |
| | | current serving cell. |
| >Cell Info | M | The following cell IDs are |
| | | supported: |
| | | GSM Cell Info |
| | | WCDMA/TD- |
| | | SCDMA Cell Info |
| | | CDMA Cell Info |
| | | WLAN AP Info |
| | | WiMAX BS Info |
| >Status | M | Describes whether or not the |
| | | cell or WLAN AP info is: |
| | | Not Current, last |
| | | known cell/AP info |
| | | Current, the present |
| | | cell/AP info |
| | | Unknown (i.e. not |
| | | known whether the |
| | | cell/AP id is current or |
| | | not current) |

With respect to the Status parameter shown in Table 1, it should be noted that the Status parameter does not apply to WCDMA/time division (TD)-synchronous code division multiple access (SCDMA) optional parameters (e.g., Frequency Info, Primary Scrambling Code and Measured Results List). Optional parameters such as Frequency Info, Primary Scrambling Code and Measured Results List, if present, are considered to be correct for the current cell.

Table 2 below shows that the WiMAX BS Info parameter can define the parameters of a WiMAX BS. It should be noted that “WiMAX measured results” in “WiMAX BS Info” are optional and can be considered to fall under the “enhanced” positioning performance level of operation described above, while a “basic” level of positioning support can be achieved by, e.g., only defining the BS ID for WiMAX. It should be also noted that for all other cellular systems supported in a Cell Info list, a system-specific protocol is carried in the existing SUPL messages.

It should further be noted that various embodiments described herein are not restricted to providing location support and/or adding support for WiMAX for cellular systems/networks utilizing the OMA SUPL protocol. Furthermore, various embodiments can further define, e.g., more generic Cell Info type information/lists as well as other parameters for which content is interpreted based on system information identification.

TABLE 2

| Parameter | Presence | Value/Description |
|---|---|---|
| WiMAX BS Info | — | WiMAX Base Station Info |
| >BS ID | M | BS ID |
| >WiMAX Measured | O | WiMAX channel |
| Results | | measuremetns |
| >>Round Trip Delay | O | Round Trip Delay (RTD) |
| | | between the SET and BS |
| >>BS Channel | O | If Round Trip Delay in |
| Bandwidth | | included this parameter |
| | | MUST be present |
| >>BS Signal | O | BS signal strength received at |
| Strength | | the SET in dBm |
| >>BS Signal | O | Standard deviation of BS |
| Strength uncertainty | | signal strength received at the |
| | | SET in dB |
| >>BS CINR | O | BS Carrier to Noise and |
| | | Interference Ratio as received |
| | | at the SET in dB |
| >>BS CINR | O | Standard deviation of BS |
| uncertainty | | Carrier to Noise and |
| | | Interference Ratio as received |
| | | at the SET in dB |

Various embodiments enable fast and easy systems and methods for including positioning support with regard to new cellular systems while, e.g., saving time and reducing the cost associated with implementing such embodiments because only minimal changes are needed, as described above. Moreover, various embodiments can improves the reliability of cellular systems/networks where they are implemented because already-tested implementations can be used as they are by only introducing new values for certain parameters. Additionally, backward compatibility issues can be avoided as well.

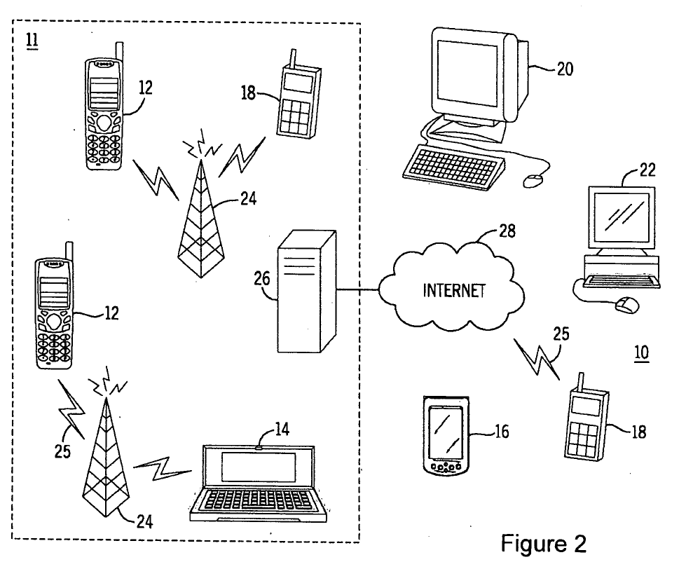

FIG. 2 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 2 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile device 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

Communication devices incorporating and implementing various embodiments may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

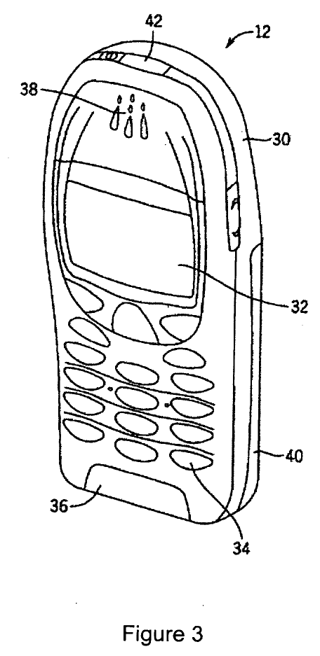

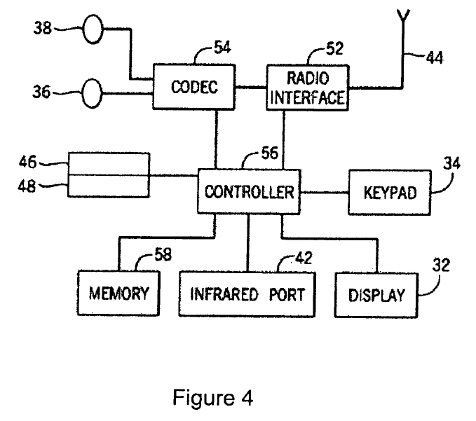

FIGS. 3 and 4 show one representative electronic device 12 within which the present invention may be implemented. It should be understood, however, that the present invention is not intended to be limited to one particular type of electronic device 12. The electronic device 12 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58 and a battery 80. Individual circuits and elements are all of a type well known in the art.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method of providing positioning support, comprising:
introducing location support into only a user plane of a first communications network; and
defining the location support to a protocol of the user plane.

2. The method of embodiment 1, wherein the location support comprises first information identifying an element of a second communications network.

3. The method of embodiment 2, wherein the first information comprises worldwide interoperability for microwave access network base station information.

4. The method of embodiment 2, wherein the first communications network and the second communications network are of differing technologies.

5. The method of embodiment 2, wherein the first information is introduced into a cell info type list of the first communications network.

6. The method of embodiment 2, wherein the second communications network comprises one of a Third Generation Partnership Project long term evolution network, a worldwide interoperability for microwave access network, and an open mobile alliance secure user plane protocol-based network.

7. The method of embodiment 2, wherein the defining of the location support comprises defining at least one parameter representative of the element identified by the first information.

8. The method of embodiment 7, wherein the at least one parameter comprises a base station identifier parameter representative of a worldwide interoperability for microwave access network base station.

9. The method of embodiment 8, wherein the at least one parameter comprises a round trip delay parameter indicative of round trip delay between the worldwide interoperability for microwave access network base station and a secure user plane location-enabled terminal.

10. The method of embodiment 8, wherein the at least one parameter comprises a base station signal strength parameter indicative of signal strength of the worldwide interoperability for microwave access network base station received at a secure user plane location-enabled terminal.

11. The method of embodiment 10, wherein the at least one parameter comprises a base station signal strength uncertainty parameter indicative of a standard deviation of the signal strength of the worldwide interoperability for microwave access network base station received at the secure user plane location-enabled terminal.

12. The method of embodiment 8, wherein the at least one parameter comprises a base station carrier to noise and interference ratio parameter indicative of a carrier to noise and interference ratio of the worldwide interoperability for microwave access network base station as received at a secure user plane location-enabled terminal.

13. The method of embodiment 12, wherein the at least one parameter comprises base station carrier to noise and interference ratio uncertainty parameter indicative of a standard deviation of the carrier to noise and interference ratio of the worldwide interoperability for microwave access network base station as received at the secure user plane location-enabled terminal.

14. The method of embodiment 1, wherein the location support comprises assistance data for a navigation system operating with least one of the first and second communications networks.

15. The method of embodiment 1, wherein the first communications network comprises one of a Third Generation Partnership Project long term evolution network, a worldwide interoperability for microwave access network, and an open mobile alliance secure user plane protocol-based network.

16. A computer program product, embodied on a compute-readable medium, configured to perform the processes of embodiment 1.

17. An apparatus, comprising:
a processor; and
a memory unit operatively coupled to the processor and including:
computer code configured to introduce location support into only a user plane of a first communications network; and
computer code configured to define the location support to a protocol of the user plane.

18. The apparatus of embodiment 17, wherein the location support comprises first information identifying an element of a second communications network.

19. The apparatus of embodiment 18, wherein the first information comprises worldwide interoperability for microwave access network base station information.

20. The apparatus of embodiment 18, wherein the first communications network and the second communications network are of differing technologies.

21. The apparatus of embodiment 18, wherein the first information is introduced into a cell info type list of the first communications network.

22. The apparatus of embodiment 18, wherein the second communications network comprises one of a Third Generation Partnership Project long term evolution network, a worldwide interoperability for microwave access network, and an open mobile alliance secure user plane protocol-based network.

23. The apparatus of embodiment 18, wherein the memory unit further comprises computer code configured to define at least one parameter representative of the element identified by the first information.

24. The apparatus of embodiment 23, wherein the at least one parameter comprises a base station identifier parameter representative of a worldwide interoperability for microwave access network base station.

25. The apparatus of embodiment 24, wherein the at least one parameter comprises a round trip delay parameter indicative of a round trip delay between the worldwide interoperability for microwave access network base station and a secure user plane location-enabled terminal.

26. The apparatus of embodiment 24, wherein the at least one parameter comprises a base station signal strength parameter indicative of signal strength of the worldwide interoperability for microwave access network base station received at a secure user plane location-enabled terminal.

27. The apparatus of embodiment 26, wherein the at least one parameter comprises a base station signal strength uncertainty parameter indicative of a standard deviation of the signal strength of the worldwide interoperability for microwave access network base station received at the secure user plane location-enabled terminal.

28. The apparatus of embodiment 24, wherein the at least one parameter comprises a base station carrier to noise and interference ratio parameter indicative of a carrier to noise and interference ratio of the worldwide interoperability for microwave access network base station as received at a secure user plane location-enabled terminal.

29. The apparatus of embodiment 28, wherein the at least one parameter comprises base station carrier to noise and interference ratio uncertainty parameter indicative of a standard deviation of the carrier to noise and interference ratio of the worldwide interoperability for microwave access network base station as received at the secure user plane location-enabled terminal.

30. The apparatus of embodiment 17, wherein the location support comprises assistance data for a navigation system operating with least one of the first and second communications networks.

31. The apparatus of embodiment 17, wherein the first communications network comprises one of a Third Generation Partnership Project long term evolution network, a worldwide interoperability for microwave access network, and an open mobile alliance secure user plane protocol-based network.

32. An apparatus, comprising:
means for introducing location support into only a user plane of a first communications network; and
means for defining the location support to a protocol of the user plane.

33. The apparatus of embodiment 32, wherein the location support comprises first information identifying an element of a second communications network.

34. The apparatus of embodiment 33, wherein the means for defining the location support comprises means for defining at least one parameter representative of the element identified by the first information.

35. The apparatus of embodiment 34, wherein the at least one parameter comprises a base station identifier parameter representative of a worldwide interoperability for microwave access network base station.
